(19) United States
(12) Patent Application Publication
(10) Pub. No.: US 2025/0190992 A1
(43) Pub. Date: Jun. 12, 2025

(54) SCORING PAYMENTS BASED ON LIKELIHOOD OF REVERSAL

(71) Applicant: The PNC Financial Services Group. Inc., Pittsburgh, PA (US)

(72) Inventors: Siena Elizabeth Romano, Washington, DC (US); Sarah Moore Parody, Colonial Beach, VA (US); Firas Kotite, San Clemente, CA (US); Andrew Patrick Lynch, Gibsonia, PA (US)

(21) Appl. No.: 18/537,134

(22) Filed: Dec. 12, 2023

(51) Int. Cl. G06Q 20/40; G06Q 20/38

(52) U.S. Cl. CPC G06Q 20/4016; G06Q 20/389

(57) ABSTRACT

Disclosed is a method, including training a machine learning model to a desired performance level on a set of training data to generate fraud prediction scores for authorized payments, and after training the machine learning model to the desired performance level, determining a first fraud prediction score for a first authorized payment to a first credit account. The machine learning model includes a plurality of gradient-boosted decision trees. Determining the first fraud prediction score comprises: receiving first payment transaction data for a first payment to the first credit account, requesting historical data associated with the first account holder and first credit account, inputting the first payment transaction data and the historical data into the machine learning model, and receiving a first fraud prediction score from the machine learning model. The method further includes determining a payment float duration for a credit card account based on the first fraud prediction score.

### BACKGROUND

The present disclosure relates to systems and methods to avoid payment fraud.

### SUMMARY

In one general aspect, the present disclosure describes a method, including training, by a training computer system, via machine learning, a machine learning model to a desired performance level on a set of training data to generate fraud prediction scores for authorized payments. The set of training data comprises historical data associated with a sample of account holders and their associated credit accounts during a period of time. The machine learning model includes a plurality of gradient-boosted decision trees. The method further includes after training the machine learning model to the desired performance level, determining, by a deployment computer system, a first fraud prediction score for a first authorized payment to a first credit account. Determining the first fraud prediction score includes electronically receiving, by the deployment computer system, first payment transaction data for a first payment to the first credit account, wherein the first credit account is associated with a first account holder. Determining the first fraud prediction score further includes electronically requesting, by the deployment computer system, historical data associated with the first account holder and first credit account in response to receipt of the first payment transaction data, inputting, by the deployment computer system, the first payment transaction data and the historical data associated with the first account holder and first credit account into the machine learning model, and electronically receiving, by the deployment computer system, a first fraud prediction score from the machine learning model. The first fraud prediction score is based on the first payment transaction data and the historical data for the first account holder. The method further includes determining, by the deployment computer system, a payment float duration for the first credit account based on the first fraud prediction score.

In another general aspect, the present disclosure describes a method, including electronically receiving, by a computer system, payment transaction data for a payment to a credit account, wherein the payment transaction data comprises an authorized payment amount, and wherein the credit account is associated with an account holder. The method further includes electronically requesting, by the computer system, historical data associated with the account holder and the credit account in response to receipt of the payment transaction data, inputting, by the computer system, the payment transaction data and the historical data for the account holder and the credit account into a machine learning model comprising a plurality of gradient-boosted decision trees, and electronically receiving, by the computer system, a fraud prediction score from the machine learning model, wherein the fraud prediction score is based on the payment transaction data and the historical data for the account holder and the credit account. The method further includes determining, by the computer system, a payment float duration for a credit account based on the fraud prediction score. If the fraud prediction score is less than a predetermined threshold, the payment float duration comprises a first duration, and if the fraud prediction score is greater than or equal to the predetermined threshold, the payment float duration comprises a second duration. The second duration is greater than the first duration. The method further includes placing a payment float on the credit account for the payment float duration. The payment float duration includes a period of time in which a credit balance to the credit account is unusable. The credit balance comprises a balance that is less than or equal to the authorized payment amount.

In yet another general aspect, the present disclosure describes a system, including a database storing historical data associated with a first account holder, and a computer system comprising a processor and a memory. The memory stores instructions executable by the processor to electronically receive first payment transaction data for a first payment amount to a first credit account associated with the first account holder, electronically request historical data associated with the first account holder from the database in response to electronic receipt of the first payment transaction data, and input the first payment transaction data and the historical data for the first account holder into a machine learning model. The machine learning model includes a plurality of gradient-boosted decision trees. The machine learning model is pre-trained on historical data associated with a sample of account holders over a period of time. The memory stores further instructions executable by the processor to electronically receive, from the machine learning model, a first fraud prediction score for the first payment transaction data based on the first payment transaction data and the historical data for the first account holder, compare the first fraud prediction score to a predetermined threshold stored in the memory, and establish a payment float duration for the first credit account based on the first fraud prediction score. The payment float duration corresponds to a first duration based on the first fraud prediction score being less than the predetermined threshold. The payment float duration corresponds to a second duration based on the first fraud prediction score being greater than or equal to the predetermined threshold. The second duration is greater than the first duration.

### BRIEF DESCRIPTION OF THE DRAWINGS

The various aspects described herein, both as to organization and methods of operation, together with further objects and advantages thereof, may best be understood by reference to the following description, taken in conjunction with the accompanying drawings as follows.

FIG. 1 illustrates a flow diagram for operating a machine learning model for payment reversal, in accordance with at least one aspect of the present disclosure.

FIG. 2 illustrates a control schematic of the payment reversal machine learning model, where the machine learning model includes gradient boosted decision trees, in accordance with at least one aspect of the present disclosure.

FIG. 3 illustrates a flow chart executable by a control circuit to generate, with a machine learning model, a probability that a credit card payment will be fraudulent and reverse, in accordance with at least one aspect of the present disclosure.

FIG. 4 illustrates a plot of example relative precision of the machine learning model, in accordance with at least one aspect of the present disclosure.

FIG. 5 illustrates a plot of example cumulative recall of the machine learning model, in accordance with at least one aspect of the present disclosure.

FIG. 6 illustrates a plot of example relative precision of the machine learning model compared to a set of rules, in accordance with at least one aspect of the present disclosure.

FIG. 7 illustrates a plot of example relative recall of the machine learning model compared to a set of rules, in accordance with at least one aspect of the present disclosure.

Corresponding reference characters indicate corresponding parts throughout the several views. The exemplifications set out herein illustrate various disclosed embodiments, is one form, and such exemplifications are not to be construed as limiting the scope thereof in any manner.

### DETAILED DESCRIPTION

First party payment fraud causes financial loss for credit card providers. Credit card providers experience first party payment fraud when an account holder makes a payment to a credit card account with no expectation of the originating bank honoring the payment. As a service to customers, payments are generally cleared and reflected in a customer's balance the following business day, but prior to the actual funds being sent from the originating institution. During this window, the account holder can use the credit card again as his balance has been reduced by the payment amount.

Current solutions to combat first party payment fraud rely on a set of rules to flag payments that may not clear. However, these rules do not catch all the payment reversals that occur and the credit card providers still incur losses due to first party payment fraud.

An alternative solution is to generate a machine learning model to determine a probability that any incoming credit card payment will reverse. The model can utilize data available to the credit card provider regarding the account holder to determine a probability for a payment from the account holder not to clear. In at least one aspect, the model utilizes payment and reversal data, account holder's balance history, account master data, and account spend activity to determine the probability that a given credit card payment will reverse. Payments with a high probability of reversal can then be floated for a predetermined amount of time (e.g. five business days), or payment float duration, so as to not allow the account holder access to the funds until the payment clears. The payment float duration can be defined as a period of time in which a credit balance to the credit account is unusable. The unusable credit balance during a payment float duration can be less than or equal to the payment amount.

As further described herein, the proposed machine learning model can catch more reversals than using a set of rules. Training a machine learning model with the data can allow the machine learning model to formulate a relationship between the data and a payment reversal for the model to produce a probability of a payment reversal based on similar data.

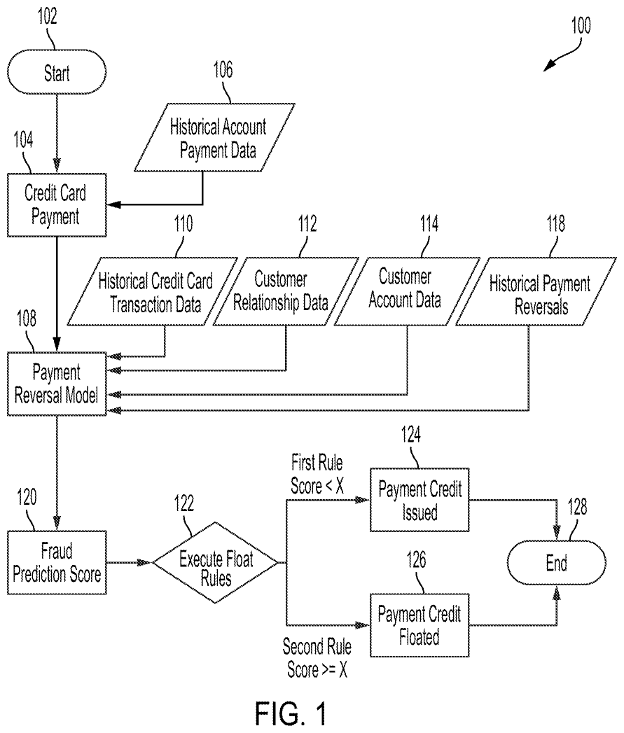

FIG. 1 illustrates a flow diagram 100 for using a machine learning model 108 for reducing the incidence of payment reversal, in accordance with at least one aspect of the present disclosure. In at least one aspect, the machine learning model 108 is an XGBoost decision tree model. However, in an alternative aspect, the machine learning model 108 can be another model (e.g. a random forest, a logistic regression, a neural network, gradient-boosted decision trees, or etc.).

The machine learning model 108 is a fraud model that produces an ordinal score measuring the risk that a payment is fraudulent. For example, the machine learning model 108 can produce a fraud prediction score (i.e. probability or risk ordinal score) from 0-1, for example, that any given credit card payment is fraudulent and, thus, will not clear (e.g. first party payment fraud). For example, the fraud prediction score is the probability that a credit card payment is fraudulent, where 0 represents a normal payment and a 1 represents a fraudulent payment. In at least one aspect, the machine learning model 108 is generating a fraud prediction score that a payment will not clear, or reverse, due to fraud. Reversals due to fraud can be followed by a period of 60+ days of delinquency within 90 days of the payment, for example.

The model can be used as an input to alert rules (e.g. floating payment rules), which also trigger alerts to go into an analyst's queue for review. An analyst review can then, if necessary, later review the payment in regard to the consumer credit card portfolio to mitigate any other future credit card payment fraud exposure. The machine learning model 108 can monitor all credit card payment transactions and ensure the appropriate payments are floated for the appropriate duration.

The flow diagram 100 begins at the start 102 block, where a plurality of credit card payments are received by a credit card provider. For example, all account holders that make a payment to their credit card balance can be determined by the credit card provider. In at least one aspect, the credit card payment data 104 can be in regard to one of the plurality of credit card payments for one account holder. In an alternative aspect, the credit card payment data 104 can include a plurality of credit card payments from one or more account holders. In at least one aspect, the credit card payment data 104 includes an authorization by the account holder to transfer a payment amount to the credit card provider from an external account. The credit card payment data 104 further includes the current credit card payment information as well as historical account payment data 106 for the account holder. In at least one aspect, the credit card payment data 104 further includes data associated with at least one of a payment network, a number of payments, and a current balance for the account holder.

The credit card payment data 104 is input into the machine learning model 108. The machine learning model 108 analyzes the credit card payment data 104 and historical data regarding the account holder to determine a probability that the current payment will reverse and be fraudulent. The historical data can be pulled from a database (e.g. a remote database). The historical data includes historical credit card transaction data 110, customer relationship data 112, customer account data 114, and historical payment reversals 118. The historical credit card transaction data 110 includes account balance history, account spend activity, account payment transaction data, account payment reversal data, and account delinquency data. The customer relationship data 112 includes data regarding the number of accounts, type of accounts, and time the accounts have been open with the account holder (e.g. covering other relationships or accounts the account holder has with the credit card provider). The customer account data 114 includes account master data regarding the account holder. The historical payment reversals data 118 include account payment reversal data and account delinquency data.

In at least one aspect, the historical data includes a value for each parameter in the historical data, where each parameter is representative of the data for the account holder of the type of historical data. For example, never having an account payment reversal can produce a high value and having a previous account payment reversal can produce a lower value for the parameter associated with historical payment reversals 118.

The historical data and the credit card payment data 104 are input into the machine learning model 108. The machine learning model 108 analyzes the credit card payment data 104 and historical data regarding the account holder to determine a fraud prediction score (i.e. probability) that the current payment is fraudulent and will reverse. The machine learning model 108 outputs a fraud prediction score 120 (i.e. a probability) that the current payment is fraudulent and will reverse.

The fraud prediction score 120 can be used to execute float rules 122. In at least one aspect, the fraud prediction score 120 can be compared to a fraud score threshold to determine a float duration (e.g. a float rule to execute). If the fraud prediction score 120 is less than the fraud score threshold, then the first float rule is executed. The first float rule corresponds to the credit card provider floating the payment credit for a first duration. In at least one aspect, the first duration can be immediate and the credit card provider can issue 124 payment credit. For example, the credit card provider can issue payment credit instantaneously. In other instances, the first duration is one business day. In at least one alternative aspect, the first duration is two business days.

If the fraud prediction score 120 is greater than or equal to the fraud score threshold, then the second float rule is executed. The second float rule corresponds to credit card provider floating 126 the payment credit for a second duration wherein the second duration is greater than the first duration. In at least one aspect, the second duration is greater than two business days. In at least one aspect, the second duration is five business days. An electronic alert can be transmitted to the credit card provider each time the fraud prediction score 120 is greater than or equal to the fraud score threshold and, thus when a longer float duration is implemented.

Once the payment credit is issued or floated, then the flow diagram 100 proceeds to the end block 128. The flow diagram 100 can be used with each payment from one or more account holders.

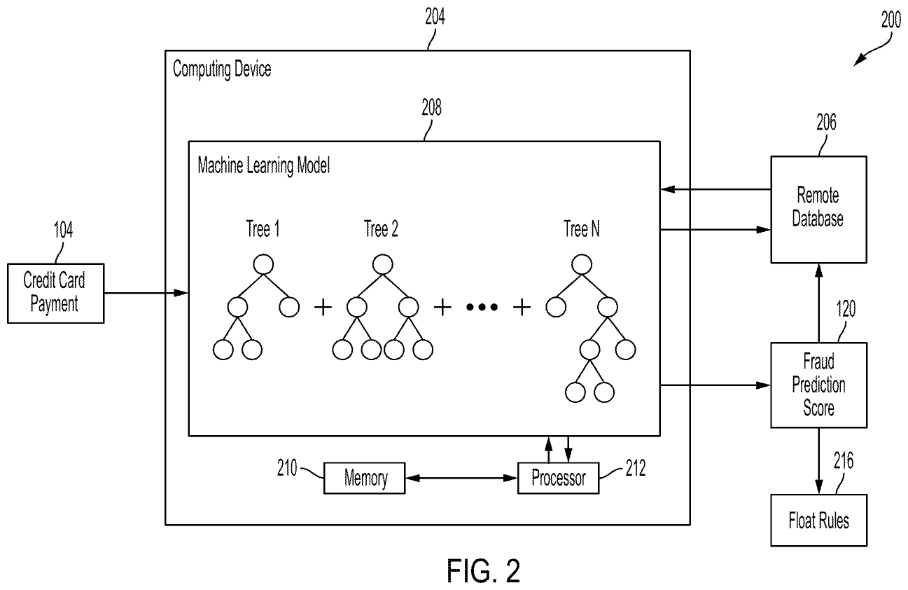

FIG. 2 illustrates a control schematic 200 of a machine learning model 208 for payment reversals, where the machine learning model 208 includes gradient boosted decision trees, in accordance with at least one aspect of the present disclosure. In various instances, the flow diagram 100 (FIG. 1) includes the machine learning model 208 in place of the machine learning model 108 (FIG. 1). While FIG. 2 illustrates the machine learning model 208 having gradient boosted decision trees, the reader will readily appreciate that other model types (e.g. random forests, logistic regressions, neural networks, etc.) can be used in the machine learning model 208. Benefits to using gradient boosted decision trees is that gradient boosted decision trees are robust, have a tendency to not over fit, and have the ability to leave data in a non-normalized format, for example.

Referring to FIG. 2, a computing device 204 (e.g. a control circuit) includes a processor 212 coupled to a memory 210. The memory 210 can store instructions representing the machine learning model 208 and the instructions can be executed by the processor 212 to run the machine learning model 208. The machine learning model 208 is one example of the machine learning model 108 of FIG. 1. As such, the machine learning model 208 receives credit card payment data 104 regarding an account holder. The machine learning model 208 then requests historical data from a remote database 206. The remote database 206 can provide the historical data for an account holder to the machine learning model 208. As discussed in regard to FIG. 1, the historical data includes historical credit card transaction data 110, customer relationship data 112, customer account data 114, and historical payment reversals 118. In at least one aspect, the historical data includes a parameter value for each type of historical data, where the parameter value is representative of the account holder's historical data for that type.

The machine learning model 208 analyzes the credit card payment data 104 and the historical data to output a fraud prediction score 120. In at least one aspect, the fraud prediction score 120 is stored in the remote database 206 and associated with the account holder. The fraud prediction score can then be used to execute float rules 216. In at least one aspect, the fraud prediction score 120 can be compared to a fraud score threshold to determine a float duration for the payment credit, as discussed in regard to FIG. 1. For example, the credit card payment amount can be floated for a first duration if the fraud prediction score 120 is less than a fraud score threshold, and the credit card payment amount is floated for a second duration if the fraud prediction score 120 is greater than or equal to the fraud score threshold, as discussed in regard to FIG. 1. In at least one aspect, the fraud score threshold is 0.5. In an alternative aspect, the fraud score threshold is 0.9. In yet another alternative aspect, the fraud score threshold is 0.945.

As illustrated in FIG. 2, the machine learning model 208 includes gradient boosted decision trees. In at least one aspect, the machine learning model 208 includes a plurality of decision trees. Each decision tree produces a fraud prediction score. The fraud prediction score from each decision tree are summed together to determine the fraud prediction score 120 output of the machine learning model 208. While it is possible to draw conclusions from a single decision tree, the combination of many trees allows for high sensitivity and precision rates when modeling an event, especially a rarely occurring event such as payment fraud, for example.

Tree-based machine learning models are able to use a large number of variables, including those which are correlated with others, to make successful predictions. Variables with few values need not be deleted prior to model estimation, because they are potentially useful. Tree algorithms are also robust enough to handle correlated features, in the sense that the presence of two highly correlated features will not undermine the model, as it can with linear regression.

In at least one aspect, the machine learning model 208 is an XGBoost model which is a type of gradient boosted decision tree model. The XGBoost model is a machine learning model based on the concept of gradient boosted decision trees and an ensemble of classification trees. Tree ensembles are a set of classification and regression trees. The XGBoost model works by additive training such that each tree iteration reduces realized error from the previous tree. In at least one aspect, gradient boosted decision trees are used for supervised learning.

The machine learning model is trained on a training dataset and evaluated with an evaluation dataset. In at least one aspect, data from a predetermined amount of time (e.g. one year) of payment transactions is used to generate the training dataset and evaluation dataset. The same account holder can make multiple payments throughout the predetermined amount of time. To avoid data from the same account holder be used for testing and validation, a unique identifier is given to each account holder and the data is split into the training dataset and the evaluation dataset such that data from each user is either in the training dataset or the evaluation dataset but not both datasets. In at least one aspect, the training dataset includes approximately 75% of the data and the evaluation dataset includes 25% of the data. In at least one aspect, the transactions that occur around national holidays (e.g. November and December transactions) are removed from the training dataset since these times tend to have more fraudulent payments. In an alternative aspect, the times around holidays remain in the training dataset.

Overall, the amount of transactions that are first party payment fraud is very small compared to the total number of payment transactions in one year. Given the degree of imbalance in the data, the machine learning model is trained on a training dataset that has been down sampled by a factor of between 1:1 and 1:20. Down sampling 1:20 means that for every fraudulent sample there are twenty non-fraudulent samples. In at least one aspect, the training data is down sampled by 1:14, where for each fraudulent sample there are 14 non-fraudulent samples.

In at least one aspect, the training dataset and evaluation dataset are evaluated to ensure that the data values are within expectations and look for outliers or unexpected values within the datasets. In some aspects, the samples with unexpected values or outliers are replaced in the two datasets. If there are missing values in the training dataset or evaluation dataset, these values are replaced with a predetermined value. In at least one aspect, the predetermined value indicates a missing value.

The machine learning model is trained in an optimization approach trained with the training dataset. In at least one aspect, the training dataset is partitioned into 80% train and 20% test for the training. The machine learning model 208, as an XGBoost model, has some hyper-parameters that are set and some hyper-parameters that are tuned. Hyper-parameters are certain values or weights that determine the learning process of an algorithm. The XGBoost hyper-parameters can be divided into four categories: general parameters, booster parameters, learning task parameters, and command line parameters. Any of the XGBoost hyper-parameters can be tuned in an optimization approach. Some example XGBoost hyper-parameters are “colsample_bytree,” which denotes the fraction of columns to be random samples for each tree, “min_child_weight,” which defines the minimum sum of weights of observations required in a child, “max_depth,” which denotes the maximum depth of a tree (e.g. between 3 and 10), gamma, which specifies the minimum loss reduction requires to make a split, and “colsample_bytree,” which denotes the fraction of columns to be random samples for each tree (e.g. between 0.3 and 1). Hyper-parameters can also include eta or learning rate, missing value imputation, early stopping on or off, “reg_alpha,” “n_estimators,” “tree_method” (e.g. automatic), “max_bin,” “eval_metric” (e.g. logloss), and “objective” (e.g. binary/logistic), for example.

After the machine learning model 208 is trained, the machine learning model 208 is evaluated. All the data is run through the machine learning model 208 and a fraud prediction score is generated for each transaction in the data. The data is input into the machine learning model 208 to simulate real data being entered into the machine learning model. For example, the data is input into the machine learning model in the order that the payment transactions were made to simulate how the data would be entered when the model is in use. The fraud prediction scores for samples associated with the evaluation dataset were then evaluated.

In at least one aspect, the fraud prediction score of each sample in the evaluation dataset is compared to a fraud score threshold to classify the payment as fraudulent or non-fraudulent. This classification is then compared to the actual outcome of the payment and an accuracy of the model is determined. The accuracy can then be compared to a threshold accuracy. If the accuracy is below the threshold accuracy, then the fraud score threshold can be adjusted (e.g. lowered or raised) or some of the parameters of the machine learning model can be adjusted and the model re-trained and evaluated again. This process can cycle until the accuracy of the machine learning model is above or equal to the accuracy threshold.

After the machine learning model has an accuracy above or equal to the accuracy threshold in regard to the evaluation dataset, then a secondary evaluation is performed. The secondary evaluation is performed using a subset of the overall data to create a secondary evaluation dataset, where the secondary evaluation dataset can include samples from the training dataset, the evaluation data, and in some instances also removed data. For example, in some aspects, data around a holiday is removed, if this data was previously removed it can be included in the secondary evaluation.

Similar to the evaluation of the evaluation dataset, the fraud prediction score of each sample in the secondary evaluation dataset is compared to the fraud score threshold to classify the payment as fraudulent or non-fraudulent. This classification is then compared to the actual outcome of the payment and an accuracy of the model is determined. The accuracy can then be compared to the threshold accuracy. If the accuracy is below the threshold accuracy, then the fraud score threshold can be adjusted (e.g. lowered or raised) or some of the parameters of the machine learning model can be adjusted and the model re-trained, the evaluation dataset can be re-evaluated, and then the secondary evaluation dataset can be evaluated again. This process can cycle until the accuracy of the machine learning model is above or equal to the accuracy threshold for the secondary evaluation dataset. At this point, the machine learning model 208 has completed the training and can be used to identify fraudulent payment and implement extended float durations, as further described herein.

When using an XGBoost model, a feature importance chart can be generated. The feature importance chart can be used to remove unimportant features. In at least one aspect, the machine learning model 208 was generated excluding the lowest 10% of features from the feature importance chart. For example, a machine learning model can be generated with all the features and then once the model in trained, a new model can be generated excluding the lowest 10% of features that were in the original model. In some aspects, the model with less features can perform similar to the model meaning those removed features were not important.

Once the model 208 is in use, the model 208 can be periodically evaluated to ensure that it is functioning properly. In at least one aspect, the performance indicators for evaluation can be at least one of precision and recall. Precision is the percentage of reversals alerted/captured divided by the total number of alerted transactions (e.g. transactions subjected to an extended duration float or hold). Recall is the percentage of reversal dollars captured. The precision and recall values for the results of the machine learning model 208 can be periodically compared to a precision threshold and a recall threshold. The precision threshold and the recall threshold can be set to extend the float duration for a minimal amount of payments while capturing a majority of the fraudulent payments. For example, the precision threshold can be adjusted to minimize the number of alerted items while the recall threshold can be adjusted to maximize the amount of reversals captured. In at least one aspect, the precision threshold is set to a value from 0% to 100% (e.g. 2%, 5%, 10%, or 25%) and the recall threshold is set to a value from 0% to 100% (e.g. 20%, 30%, 50%, or 75%) where the model 208 is evaluated so that the precision value and recall value for the results are above the thresholds.

When the performance metrics breach the thresholds defined above, a notification is transmitted to the credit card provider. The credit card provider can then evaluate the cause of the threshold breach. The credit card provider can then apply a countermeasure to increase precision and/or recall to above the thresholds. For example, the fraud score threshold can be adjusted. Additionally or alternatively, the countermeasure(s) can comprise updating features if there issues with the features or with the data being used, for example. If the credit card provider cannot determine any countermeasures that can be put in place to increase precision and/or recall to above the thresholds then, the machine learning model 208 can be re-trained and evaluated with a new data for a new training dataset and a new evaluation dataset. In at least one aspect, the new data for the retaining and evaluating is over a different time period than the original training and evaluation of the model 208. In at least one aspect, the new data for the retaining and evaluating has a different sample of account holders and their associated credit accounts.

In at least one aspect, the results of the machine learning model 208 can be evaluated over a quarterly period. In an alternative aspect, the results of the machine learning model 208 can be evaluated over a year. In yet another aspect, the results of the machine learning model 208 can be evaluated daily over a yearly and/or quarterly period or any other desired period of time.

The data to be used to run the model 208 can be processed exactly like the data used to develop and train the model. For example, the data can be fed into the model during training and evaluation the same way that data is fed into the model 208 during use. Any missing values in the data are replaced with a predetermined value. In at least one aspect, the predetermined value indicates a missing value.

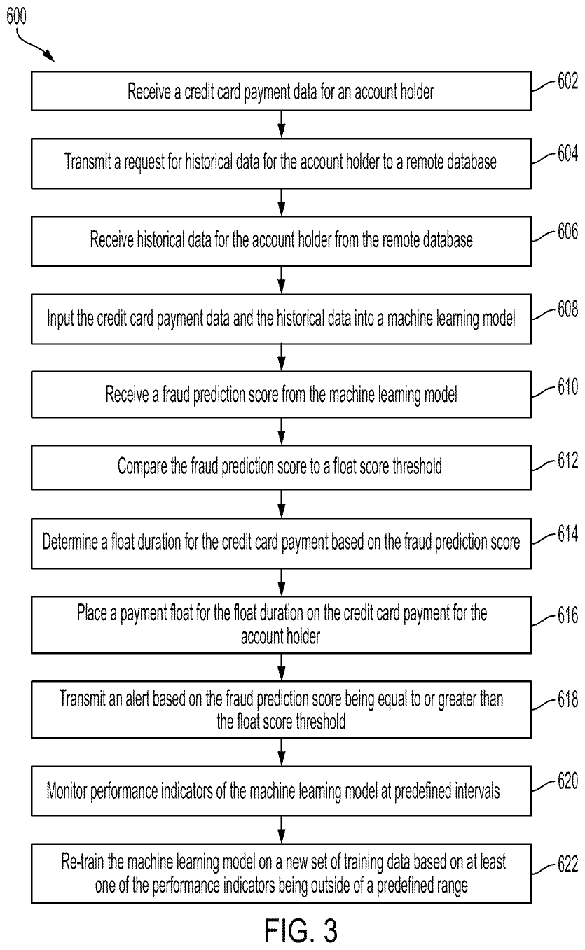

FIG. 3 illustrates a method 600 that can be executed by a control circuit (e.g. computing device 204) to generate, with the machine learning model 208, for example, a probability that a credit card payment will be fraudulent and reverse (i.e. not clear), in accordance with at least one aspect of the present disclosure. The method 600 includes the control circuit receiving 602 a credit card payment for an account holder. The method 600 further includes the control circuit transmitting 604 a request for historical data for the account holder to a remote database (e.g. remote database 206). The method 600 further includes the control circuit receiving 606 historical data for the account holder from the remote database. In at least one aspect, the historical data includes historical credit card transaction data 110, customer relationship data 112, customer account data 114, and historical payment reversals 118. In at least one aspect, the historical data includes a parameter value for each type of historical data, where the parameter value is representative of the account holder's historical data for that type.

The method 600 further includes the control circuit inputting 608 the credit card payment data and the historical data into a machine learning model (e.g. machine learning model 208). The method 600 further includes the control circuit receiving 610 a fraud prediction score (e.g. fraud prediction score 120) from the machine learning model. The method 600 further includes the control circuit comparing 612 the fraud prediction score to a float score threshold (e.g. as discussed in regard to FIGS. 1 and 2). The method 600 further includes the control circuit determining 614 a float duration for the credit card payment based on the fraud prediction score (e.g. as discussed in regard to FIGS. 1 and 2). The method 600 further includes the control circuit, or another control circuit, placing 616 a payment float for the float duration on the credit card payment for the account holder.

The method 600 further includes the control circuit transmitting 618 an alert based on the fraud prediction score being equal to or greater than the float score threshold. In at least one aspect, an alert can be transmitted to the credit card provider each time the fraud prediction score is equal to or greater than the float score threshold. The method 600 further includes the control circuit, or another control circuit, monitoring 620 performance indicators of the machine learning model at predefined intervals (e.g. as discussed in regard to FIG. 2). The method 600 further includes the control circuit, or another control circuit, re-training 622 the machine learning model on a new set of training data based on at least one of the performance indicators being outside of a predefined range (e.g. as discussed in regard to FIG. 2). In various instances, a first control circuit can train the machine learning model and a second control circuit can apply the machine learning model to a transaction.

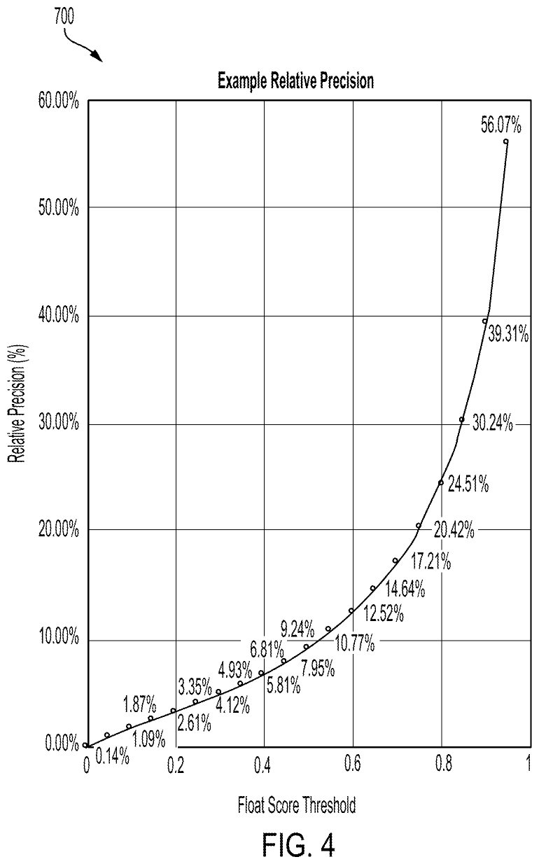

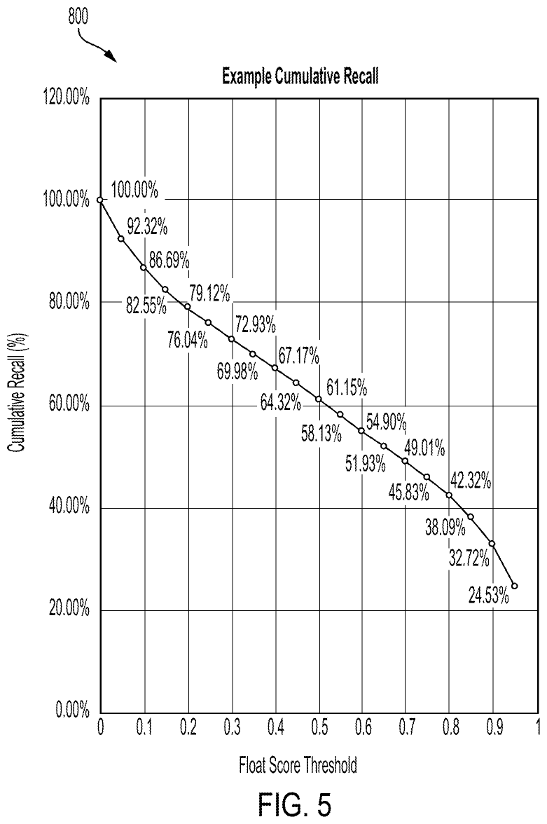

FIGS. 4-7 illustrate some example results of the machine learning model 208. FIG. 4 illustrates a plot 700 of example relative precision of the machine learning model 208, and FIG. 5 illustrates a plot 800 of example cumulative recall of the machine learning model 208.

Referring to FIG. 4, as the fraud score threshold is increased, the relative precision of the model 208 increases. For example, for a fraud score threshold of zero, which is the minimum possible fraud score, all payments (fraudulent and non-fraudulent) would be identified as fraudulent. In such instances, a large number of non-fraudulent payments, i.e. those not resulting in a payment reversal, would be subject to an unnecessarily longer duration float. As the fraud score threshold approaches the opposite end of the spectrum, e.g. a score of 1, the precision of the model improves and fewer non-fraudulent payments are being tagged as fraudulent. For example, as the fraud score threshold approaches the score of 1 in FIG. 4, the precision of the model exceeds 50% indicating that more than half of the payments tagged by the model as being fraudulent actually correspond to a payment reversal. In at least one aspect, the slope of the relative precision curve on plot 700 increases as the fraud score threshold is increased toward 1.

Referring to FIG. 5, as the fraud score threshold is increased, the cumulative recall of the model 208 decreases. For example, as the fraud score threshold is increased, the cumulative percentage of reversal dollars captured decreases. More specifically, for a fraud score threshold of zero, which is the minimum possible fraud score, all funds would be recalled because all payments (fraudulent and non-fraudulent) would be flagged as “fraudulent” and, thus, subject to an extended float time duration. Due to the extended float time duration, a bad actor would be unable to accrue additional credit card debt over the limit because the payment would be floated long enough to confirm the unavailability of the funds. As the fraud score threshold approaches the opposite end of the spectrum, e.g. a score of 1, the recall of the model declines as fewer fraudulent payments are being tagged as fraudulent. For example, as the fraud score threshold approaches the score of 1 in FIG. 5, the cumulative recall of the model drops below 25% indicating that less than a quarter of fraudulent payments are successfully recalled.

By overlying the data from the plots 700 and 800, the fraud score threshold can be optimized to maximize reversal dollars while minimizing identification of non-fraudulent transactions as being fraudulent and likely to result in payment reversal. Stated another way, the fraud score threshold can be optimized to maximize reversal dollars while minimizing the effect on non-fraudulent customers. In various instances, the cumulative recall can be optimized at greater than 30%, for example, and the cumulative precision can be optimized at less than 10%, for example. The exemplary plots in FIGS. 4 and 5, for example, can be used by a user to determine a float score threshold that satisfies a desired relative cumulative recall and a desired relative precision.

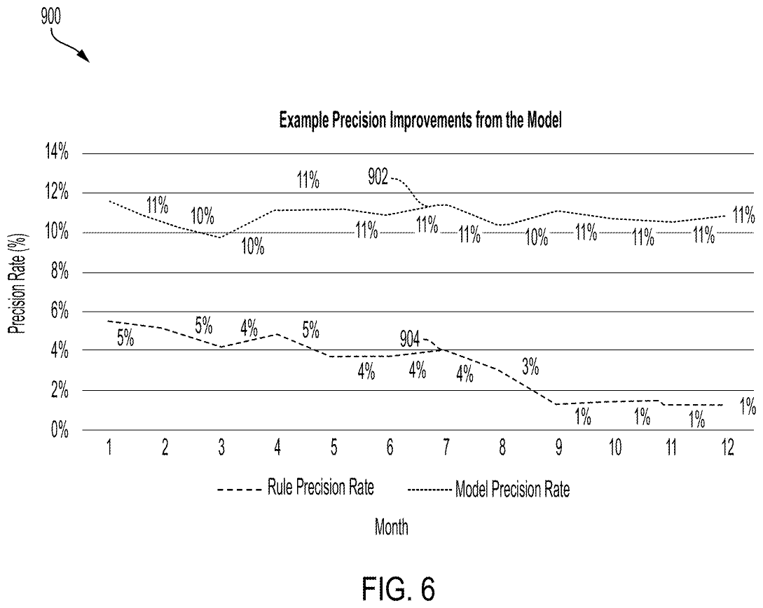

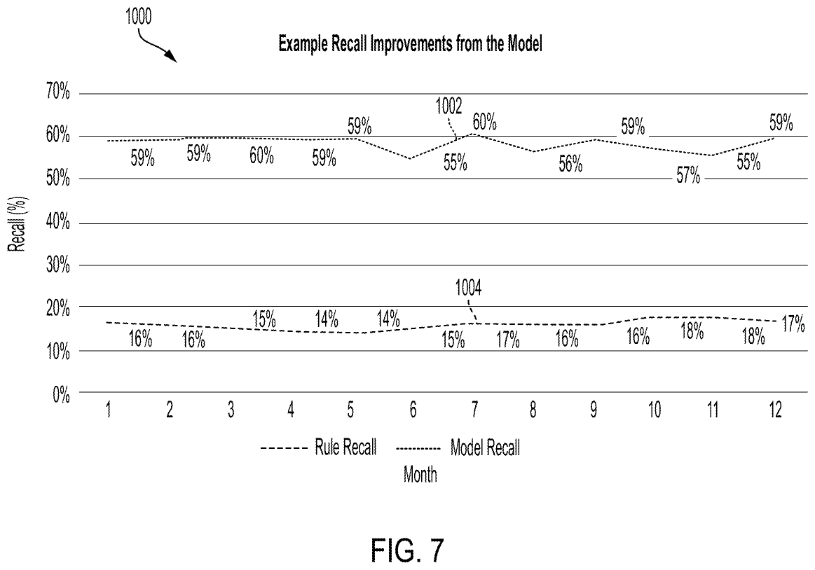

FIG. 6 illustrates a plot 900 of example relative precision of the machine learning model 208 compared to a set of rules, and FIG. 7 illustrates a plot 1000 of example relative recall of the machine learning model 208 compared to a set of rules. Referring to FIG. 6, the model 208 has a precision rate 902 that greater than the rule precision rate 904 across the entire year. Referring to FIG. 7, the model 208 has a recall 1002 that is greater than the recall 1004 of the set of rules across the entire year. The results of the machine learning model 208 are an improvement over a set of rules, as shown in FIGS. 6 and 7.

In various instances, the machine learning model utilized to characterize credit card payments can rely on one or more general assumptions. For example, the model can assume independent, identically distributed data. In other words, the model assumes that the data used for training and testing follow a similar probability distribution and the data points are independent of each other. The model can also assumes local constancy where the learned function does not vary widely around its neighborhood. For example, if two samples are close in the input space, their labels are expected to be the same. The model can also assume that features not captured in the model have a minimal effect on the final predictability of the dependent variable. The model can also assume that the data used for development is based on the production information available at the time the model is generated.

In at least one aspect, the machine learning model results are periodically reviewed to ensure the model purpose and design remain accurate, complete, and consistent. For example, reports derived from the model outputs can be reviewed for accuracy and completeness. By systematically monitoring the model results over time the credit card provider can better understanding of the patterns and responsiveness of the model to varying conditions or applications. The credit card provider can track cases where model outcomes are altered or ignored which may indicate a need to improve the model. The credit card provider can gauge model results against available benchmarks for the model. The credit card owner can compare the model output to expected results or actual outcomes and assess the reasons for any observed variations between the two. This assessment may involve the use of statistical tests or other quantitative measures, but can also be based on expert judgment to confirm the results make sense relative to expectations.

Various aspects of the subject matter described herein are set out in the following numbered Clauses.

Clause 1—a method, including training, by a training computer system, via machine learning, a machine learning model to a desired performance level on a set of training data to generate fraud prediction scores for authorized payments. The set of training data comprises historical data associated with a sample of account holders and their associated credit accounts during a period of time. The machine learning model includes a plurality of gradient-boosted decision trees. The method further includes after training the machine learning model to the desired performance level, determining, by a deployment computer system, a first fraud prediction score for a first authorized payment to a first credit account. Determining the first fraud prediction score includes electronically receiving, by the deployment computer system, first payment transaction data for a first payment to the first credit account, wherein the first credit account is associated with a first account holder. Determining the first fraud prediction score further includes electronically requesting, by the deployment computer system, historical data associated with the first account holder and first credit account in response to receipt of the first payment transaction data, inputting, by the deployment computer system, the first payment transaction data and the historical data associated with the first account holder and first credit account into the machine learning model, and electronically receiving, by the deployment computer system, a first fraud prediction score from the machine learning model. The first fraud prediction score is based on the first payment transaction data and the historical data for the first account holder. The method further includes determining, by the deployment computer system, a payment float duration for the first credit account based on the first fraud prediction score.

Clause 2—the method of Clause 1, wherein determining the payment float duration includes comparing the first fraud prediction score to a predetermined threshold, if the first fraud prediction score is less than the predetermined threshold, placing a payment float of a first duration on the first credit account, and if the first fraud prediction score is greater than or equal to the predetermined threshold, placing a payment float of a second duration on the first credit account, wherein the second duration is greater than the first duration.

Clause 3—the method of Clause 2, further includes generating an electronic alert based on the first fraud prediction score exceeding the predetermined threshold.

Clause 4—the method of Clauses 1, 2, or 3, further includes monitoring, by the deployment computer system, a plurality of performance indicators of the machine learning model at predefined intervals. The plurality of performance indicators are selected from a group of performance indicators consisting of a precision parameter corresponding to a percentage of payment reversals during the predefined interval over the number of electronic alerts generated during the predefined interval, and a recall parameter corresponding to an amount of funds captured during the predefined interval as a result of the payment float duration determined by the deployment computer system.

Clause 5—the method of Clause 4, further includes re-training, by the training computer system, the machine learning model on a second set of training data based on at least one of the performance indicators being outside of a predefined range of suitable values.

Clause 6—the method of Clause 5, wherein the second set of training data includes historical data associated with the sample of account holders and their associated credit accounts during a different period of time.

Clause 7—the method of Clause 6, wherein the second set of training data includes historical data associated with a different sample of account holders and their associated credit accounts.

Clause 8—the method of Clauses 1, 2, 3, 4, 5, 6, or 7, wherein training the set of training data includes fraudulent data samples and non-fraudulent data samples, and wherein the method further comprises down sampling the non-fraudulent data samples at a rate of between 1:1 and 1:20.

Clause 9—the method of Clause 8, wherein down sampling the non-fraudulent data samples comprises down sampling non-fraudulent data samples such that fourteen non-fraudulent data samples are utilized for each fraudulent data sample in the set of training data.

Clause 10—a method, including electronically receiving, by a computer system, payment transaction data for a payment to a credit account, wherein the payment transaction data comprises an authorized payment amount, and wherein the credit account is associated with an account holder. The method further includes electronically requesting, by the computer system, historical data associated with the account holder and the credit account in response to receipt of the payment transaction data, inputting, by the computer system, the payment transaction data and the historical data for the account holder and the credit account into a machine learning model comprising a plurality of gradient-boosted decision trees, and electronically receiving, by the computer system, a fraud prediction score from the machine learning model, wherein the fraud prediction score is based on the payment transaction data and the historical data for the account holder and the credit account. The method further includes determining, by the computer system, a payment float duration for a credit account based on the fraud prediction score. If the fraud prediction score is less than a predetermined threshold, the payment float duration comprises a first duration, and if the fraud prediction score is greater than or equal to the predetermined threshold, the payment float duration comprises a second duration. The second duration is greater than the first duration. The method further includes placing a payment float on the credit account for the payment float duration. The payment float duration includes a period of time in which a credit balance to the credit account is unusable. The credit balance comprises a balance that is less than or equal to the authorized payment amount.

Clause 11—a system, including a database storing historical data associated with a first account holder, and a computer system comprising a processor and a memory. The memory stores instructions executable by the processor to electronically receive first payment transaction data for a first payment amount to a first credit account associated with the first account holder, electronically request historical data associated with the first account holder from the database in response to electronic receipt of the first payment transaction data, and input the first payment transaction data and the historical data for the first account holder into a machine learning model. The machine learning model includes a plurality of gradient-boosted decision trees. The machine learning model is pre-trained on historical data associated with a sample of account holders over a period of time. The memory stores further instructions executable by the processor to electronically receive, from the machine learning model, a first fraud prediction score for the first payment transaction data based on the first payment transaction data and the historical data for the first account holder, compare the first fraud prediction score to a predetermined threshold stored in the memory, and establish a payment float duration for the first credit account based on the first fraud prediction score. The payment float duration corresponds to a first duration based on the first fraud prediction score being less than the predetermined threshold. The payment float duration corresponds to a second duration based on the first fraud prediction score being greater than or equal to the predetermined threshold. The second duration is greater than the first duration.

Clause 12—the system of Clause 11, wherein the payment float duration includes a period of time in which a credit balance to the first credit account is unusable, and wherein the credit balance includes a balance that is less than or equal to the first payment amount.

Clause 13—the system of Clauses 11 or 12, wherein the first payment transaction data includes data associated with at least one of a payment network, a number of payments, and a current balance on the first credit account, and wherein the historical data associated with the sample of account holders comprises data associated with at least one of account balance history, account spend activity, account payment transaction data, account payment reversal data, account delinquency data, and account master data for each of the account holders in the sample of account holders over the period of time.

Clause 14—the system of Clauses 11, 12, or 13, wherein types of historical data associated with the first account holder correspond to types of historical data associated with the sample of account holders over the period of time.

Clause 15—the system of Clauses 11, 12, 13, or 14, wherein the first duration is less than two business days, and the second duration is more than two business days.

Clause 16—the system of Clauses 11, 12, 13, or 14, wherein the first duration is one business day. In at least one aspect, the second duration is five business days.

Clause 17—the system of Clauses 11, 12, 13, 14, 15, or 16, wherein the memory stores further instructions executable by the processor to transmit an electronic alert based on the first fraud prediction score being greater than or equal to the predetermined threshold.

Clause 18—the system of Clauses 11, 12, 13, 14, 15, 16, or 17, wherein the machine learning model comprises a XGBoost model.

Clause 19—the system of Clauses 11, 12, 13, 14, 15, 16, 17, or 18, wherein the first fraud prediction score represents a likelihood that the first payment amount will reverse from the first credit account.

Clause 20—the system of Clauses 11, 12, 13, 14, 15, 16, 17, 18, or 19, wherein the first payment transaction data includes an authorization by the first account holder to transfer a first payment amount to the first credit account from an external account. In at least one aspect, the first fraud prediction score represents a likelihood of fraud being associated with the authorization by the first account holder.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a control circuit computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method, comprising:
training, by a training computer system, via machine learning, a machine learning model to a desired performance level on a set of training data to generate fraud prediction scores for authorized payments, wherein the set of training data comprises historical data associated with a sample of account holders and their associated credit accounts during a period of time, and wherein the machine learning model comprises a plurality of gradient-boosted decision trees; and
after training the machine learning model to the desired performance level, determining, by a deployment computer system, a first fraud prediction score for a first authorized payment to a first credit account, wherein determining the first fraud prediction score comprises:
electronically receiving, by the deployment computer system, first payment transaction data for a first payment to the first credit account, wherein the first credit account is associated with a first account holder;
electronically requesting, by the deployment computer system, historical data associated with the first account holder and first credit account in response to receipt of the first payment transaction data;
inputting, by the deployment computer system, the first payment transaction data and the historical data associated with the first account holder and first credit account into the machine learning model; and
electronically receiving, by the deployment computer system, a first fraud prediction score from the machine learning model, wherein the first fraud prediction score is based on the first payment transaction data and the historical data for the first account holder; and
determining, by the deployment computer system, a payment float duration for the first credit account based on the first fraud prediction score.

2. The method of claim 1, wherein determining the payment float duration comprises:
comparing the first fraud prediction score to a predetermined threshold;
if the first fraud prediction score is less than the predetermined threshold, placing a payment float of a first duration on the first credit account; and
if the first fraud prediction score is greater than or equal to the predetermined threshold, placing a payment float of a second duration on the first credit account, wherein the second duration is greater than the first duration.

3. The method of claim 2, further comprising generating an electronic alert based on the first fraud prediction score exceeding the predetermined threshold.

4. The method of claim 1, further comprising monitoring, by the deployment computer system, a plurality of performance indicators of the machine learning model at predefined intervals, wherein the plurality of performance indicators are selected from a group of performance indicators consisting of:
a precision parameter corresponding to a percentage of payment reversals during the predefined interval over a number of electronic alerts generated during the predefined interval; and
a recall parameter corresponding to an amount of funds captured during the predefined interval as a result of the payment float duration determined by the deployment computer system.

5. The method of claim 4, wherein the method further comprises re-training, by the training computer system, the machine learning model on a second set of training data based on at least one of the performance indicators being outside of a predefined range of suitable values.

6. The method of claim 5, wherein the second set of training data comprises historical data associated with the sample of account holders and their associated credit accounts during a different period of time.

7. The method of claim 5, wherein the second set of training data comprises historical data associated with a different sample of account holders and their associated credit accounts.

8. The method of claim 1, wherein training the set of training data comprises fraudulent data samples and non-fraudulent data samples, and wherein the method further comprises down sampling the non-fraudulent data samples at a rate of between 1:1 and 1:20.

9. The method of claim 8, wherein down sampling the non-fraudulent data samples comprises down sampling non-fraudulent data samples such that fourteen non-fraudulent data samples are utilized for each fraudulent data sample in the set of training data.

10. A method, comprising:
electronically receiving, by a computer system, payment transaction data for a payment to a credit account, wherein the payment transaction data comprises an authorized payment amount, and wherein the credit account is associated with an account holder;
electronically requesting, by the computer system, historical data associated with the account holder and the credit account in response to receipt of the payment transaction data;
inputting, by the computer system, the payment transaction data and the historical data for the account holder and the credit account into a machine learning model comprising a plurality of gradient-boosted decision trees;
electronically receiving, by the computer system, a fraud prediction score from the machine learning model, wherein the fraud prediction score is based on the payment transaction data and the historical data for the account holder and the credit account; and
determining, by the computer system, a payment float duration for a credit account based on the fraud prediction score, wherein:
if the fraud prediction score is less than a predetermined threshold, the payment float duration comprises a first duration, and
if the fraud prediction score is greater than or equal to the predetermined threshold, the payment float duration comprises a second duration, wherein the second duration is greater than the first duration; and
placing a payment float on the credit account for the payment float duration, wherein the payment float duration comprises a period of time in which a credit balance to the credit account is unusable, and wherein the credit balance comprises a balance that is less than or equal to the authorized payment amount.

11. A system, comprising:
a database storing historical data associated with a first account holder; and
a computer system comprising a processor and a memory, wherein the memory stores instructions executable by the processor to:
electronically receive first payment transaction data for a first payment amount to a first credit account associated with the first account holder;
electronically request historical data associated with the first account holder from the database in response to electronic receipt of the first payment transaction data;
input the first payment transaction data and the historical data for the first account holder into a machine learning model, wherein the machine learning model comprises a plurality of gradient-boosted decision trees, and wherein the machine learning model is pre-trained on historical data associated with a sample of account holders over a period of time;
electronically receive, from the machine learning model, a first fraud prediction score for the first payment transaction data based on the first payment transaction data and the historical data for the first account holder;
compare the first fraud prediction score to a predetermined threshold stored in the memory; and
establish a payment float duration for the first credit account based on the first fraud prediction score, wherein the payment float duration corresponds to a first duration based on the first fraud prediction score being less than the predetermined threshold, wherein the payment float duration corresponds to a second duration based on the first fraud prediction score being greater than or equal to the predetermined threshold, and wherein the second duration is greater than the first duration.

12. The system of claim 11, wherein the payment float duration comprises a period of time in which a credit balance to the first credit account is unusable, and wherein the credit balance comprises a balance that is less than or equal to the first payment amount.

13. The system of claim 11, wherein the first payment transaction data comprises data associated with at least one of a payment network, a number of payments, and a current balance on the first credit account, and wherein the historical data associated with the sample of account holders comprises data associated with at least one of account balance history, account spend activity, account payment transaction data, account payment reversal data, account delinquency data, and account master data for each of the account holders in the sample of account holders over the period of time.

14. The system of claim 13, wherein types of historical data associated with the first account holder correspond to types of historical data associated with the sample of account holders over the period of time.

15. The system of claim 11, wherein the first duration is less than two business days, and wherein the second duration is more than two business days.

16. The system of claim 15, wherein the first duration is one business day, and wherein the second duration is five business days.

17. The system of claim 11, wherein the memory stores further instructions executable by the processor to transmit an electronic alert based on the first fraud prediction score being greater than or equal to the predetermined threshold.

18. The system of claim 11, wherein the machine learning model comprises a XGBoost model.

19. The system of claim 11, wherein the first fraud prediction score represents a likelihood that the first payment amount will reverse from the first credit account.

20. They system of claim 11, wherein the first payment transaction data comprises an authorization by the first account holder to transfer a first payment amount to the first credit account from an external account, and wherein the first fraud prediction score represents a likelihood of fraud being associated with the authorization by the first account holder.
